(19) United States
(12) Patent Application Publication
(10) Pub. No.: US 2009/0292613 A1
(43) Pub. Date: Nov. 26, 2009

(54) Method for creating a user profile

(76) Inventor: Reuben Berman, Beer Sheva (IL)

Correspondence Address: Reuben Berman, P.O. Box 3773, Beer-Sheva, IL

(21) Appl. No.: 12/468,060

(22) Filed: May 19, 2009

(30) Foreign Application Priority Data
May 26, 2008 (IL) 191706

(51) Int. Cl. G06F 17/30; G06F 7/00; G06F 12/14; G06F 21/00

(52) U.S. Cl. 705/14.66; 707/5; 707/102; 726/24; 707/10; 707/E17.014

(57) ABSTRACT

In one aspect, the present invention is directed to a method for creating a user profile, the method comprising the steps of: while scanning a group of files of a user (an individual, a plurality of individuals, an organization, and so on): searching for keywords in the group of files; counting the number of instances of each of the found keywords in the files; and determining a user profile from the found keywords and/or the number of instances. The method may further comprise the step of providing information pertinent to the determined user profile. Such information may be ads while browsing a Web site. The method may further comprise the step of remunerating the user for allowing use of the determined profile for focusing information provision to the user, such as allowing the user to use an antivirus program free of charge.

The current application claims the benefit of Israeli Patent Application No. 191706, filed May 26, 2008, which is incorporated herein by reference.

### FIELD OF THE INVENTION

The present invention relates to the field of providing information to a user. More particularly, the present invention relates to creating a user profile for means of focusing information presented to a user.

### BACKGROUND OF THE INVENTION

One of the major financial powers maintaining the Internet is advertising. It is doubtful that certain Web sites could survive without being used as advertising channel. For example, the major income of some news Web sites is from advertising. The way such Web sites operate is actually a business model: on the one hand, the user does not pay for their service, i.e., the right to browse the news, but on the other hand, by browsing the news, users are exposed to ads.

Presently user-oriented advertising on Web sites is very common. In this type of advertising, the ads presented to a user are directed to his profile. For example, in some Web sites a user must be registered as a member to gain access to the services they provide. In the registration process, the user fills a questionnaire in which he notes individual fields of interest, and so on. When the user browses the Web site, the ads displayed to the user are of the fields of interest declared in the questionnaire.

An alternative approach to information provision to Web users makes use of keywords instead of, or in addition to, questionnaires. This approach is common in search engines such as Google™. Upon providing by a user a keyword query matching an advertiser's keyword list, the advertiser's ad is presented. These ads are called “sponsored links” or “sponsored ads”. Sponsored links usually appear next to, and sometimes above, the natural or organic results on search engine results pages, or anywhere a webmaster/Blogger chooses on a content page. This approach is also used with email clients operated by Web pages (in contrast to mail client programs like Outlook).

One of the most popular business models in Internet advertising is called “pay-per-click”. According to this model, an advertiser pays only when a user actually clicks on an ad to visit the advertiser's Web site. Advertisers bid on keywords they believe their target market would type in the search bar when they are looking for a product or service. The search engine of Google™ uses this model.

The above-mentioned technologies of obtaining a user profile have some drawbacks. Filling in a questionnaire is a burden to some users. Accordingly, such users may prefer to avoid services of a Web site rather than complete the questionnaire. Other users prefer to fill false details, or provide only the minimal information the questionnaire requires. In all these cases, the ads presented to the users may not be focused. Keywords oriented ads, such as those used by Google™, may not be focused as well, since this kind of advertising is not directed to a user profile.

It is an object of the resent invention to provide a technology for obtaining a user profile, which is not a burden to the user.

It is another object of the resent invention to provide a technology for obtaining a user profile, which characterizes the user in a more detailed and specific manner than in the prior art.

Other objects and advantages of the invention will become apparent as the description proceeds.

### SUMMARY OF THE INVENTION

In one aspect, the present invention is directed to a method for creating a user profile, the method comprising the steps of:
while scanning a group of files of a user (an individual, a plurality of individuals, an organization, and so on):
   searching for keywords in the group of files;
   counting the number of instances of each of the found keywords in these files; and
   determining a profile (i.e., keywords associated with a user) of the user from the found keywords and/or the number of instances.

The method may further comprise the step of providing information pertinent to the determined profile to the user. Such information may be ads to be presented to the user while browsing a Web site.

The method may further comprise the step of remunerating the user for allowing using the determined profile for focusing information provision to the user.

According to one embodiment of the invention, the remuneration is using an antivirus program free of charge, or at least for a reduced charge.

A keyword may be one or more words associated with the keyword, inflection(s) of a word, synonym(s) of a word, and so on.

According to one embodiment of the invention, the keywords are determined using compilation technology.

Determining a user profile from the found keywords may be carried out using a criterion thereof. For example, in order to determine that a sport field is within the user's field of interest (i.e., included in user's profile), at least X % of the found keywords must be related to the sport field.

According to one embodiment of the invention, a plurality of user profiles are defined in advance, and the user is related to one or more of these profiles by the number of instances of keywords associated with the profile.

According to another embodiment of the invention, the keywords are determined during the scan, from the found words during the scan.

Preferably, the scanning of a group of files is carried out as a part of an antivirus scan.

The scanning may be carried out on files of a computer, a cellular apparatus, a network gateway, a proxy server, and so on. The scanning may be carried out on-the-fly (i.e., data passing through) as well as off-the-fly (i.e., files present on storage media). The files may be human-readable files such as text files, Web files, computer registry, information stored on a disk, data passed via a port, temporary files, temporary files of a Web browser, lists of files, and so on.

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 is a flowchart that schematically illustrates a method for obtaining a user profile, according to one embodiment of the invention.

FIG. 2 schematically illustrates a simple example for determining a user's profile from a text file, according to one embodiment of the invention.

FIG. 3 schematically illustrates a simplified example for determining a user's profile from a text file, according to another embodiment of the invention.

FIG. 4 schematically illustrates a structure of a user profile, according to one embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

In order to facilitate the reading to follow, the following terms are defined:

The term “virus” refers herein to any malicious content, such as viruses, worms, spyware, and so on.

The term “file” refers herein to any data storage facility. This may include text files (e.g., of a word processor or text editor), Web files, computer registry, disk storage, temporary files, temporary files of a Web browser, list of files (file entries in a files directory), data passed via a port, data passed through a proxy server, data passed through a network gateway, and so on.

The term “profile” refers herein to one or more keywords associated with a user, an organization (i.e., a group of users), an idea, a concept, an object, and so on.

Advertising is a kind of information that can be provided to a user. As such, the prior art models of advertising presented in the “Background of the Invention” chapter of this document are actually models of information provision. Other categories of information that can be provided in the same manner are breaking news, sports match results, weather forecasts, sales data, and so on.

The present invention presents a novel technology of obtaining a user profile. According to embodiments of the present invention, antivirus activity is employed for obtaining a user's profile. The user profile may be used in a later stage for focusing information provided to the user, such as ads.

Antivirus software is a computer program that attempts to identify, neutralize or eliminate malicious software. Antivirus is so named because the earliest examples were designed exclusively to combat computer viruses; however, most modern antivirus software is now designed to combat a wide range of threats, including worms, phishing attacks, rootkits, Trojan horses and other types of malware.

Presently, technologies for accomplishing this are very common. For example, one technology is based on scanning a file in order to detect known patterns associated with viruses (“virus signature”). Another technology is based on detecting suspicious behavior of a computer program, a computer, and so on. Such analysis may include data captures, port monitoring and other methods.

Antivirus activity may be performed by scanning the files of a computer, listening to ports, scanning incoming files to the computer, scanning outgoing files from the computer, scanning the registry of a computer, and so on. Antivirus activity may be performed as a high priority process of a computer, as a background process, and so on.

Presently, it is rare to find a personal computer that does not employ an antivirus program. Antivirus programs may also operate in a network gateway, a proxy server, and so on. Thus, antivirus programs may operate on the individual, as well as organization, level.

Since antivirus programs scan files on a user's computer, according to embodiments of the present invention, the scanning process is also employed for detecting keywords in the scanned files. The keywords and their frequency in a user's files are used to create a user profile, which can be later used to focus information that will be presented to the user.

According to one embodiment of the invention, a user profile is embodied as a group of keywords associated with the user's fields of interest. For example, a user whose profile comprises the keywords “sun”, “beach”, “resort”, “spa”, “holiday” and so on, may be categorized as a user interested in holidays and travel.

According to one embodiment of the present invention, the keywords with the higher number of instances in a user's files determine the user's profile. For example, the profile of a user is composed of 5% of the most common keywords of his documents.

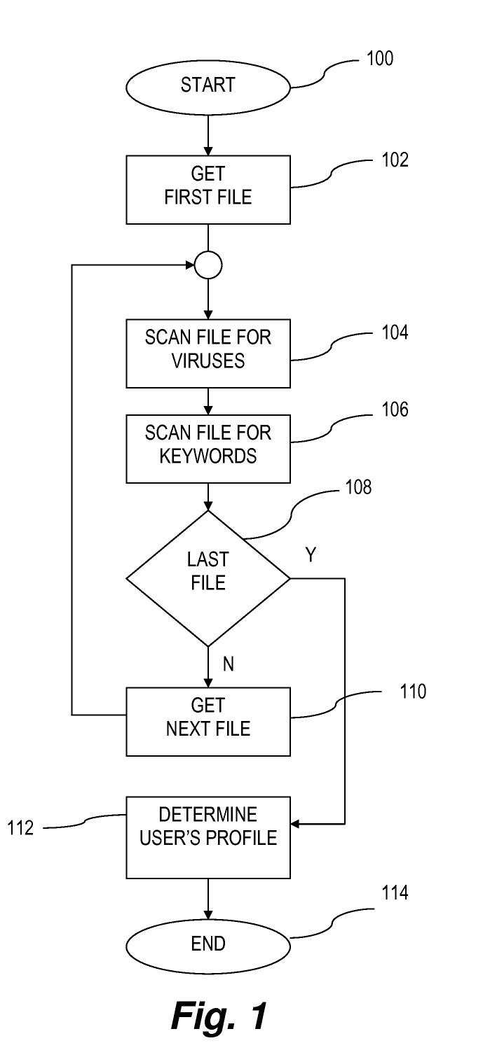

FIG. 1 is a flowchart that schematically illustrates a process for obtaining a user profile, according to one embodiment of the invention.

The process starts at block 100, when activating an antivirus scan of a group of files of a computer, such as the files of a folder, the files of a disk, the files of the entire computer, and so on.

At block 102, the first file is accessed. For example, the file is loaded into memory, a pointer is placed at the start of the file, etc.

At block 104, an antivirus program scans a file in order to detect viruses, e.g., by searching string patterns associated with a virus (“virus signature”).

At block 106, the file is scanned for detecting keywords. A database (not illustrated in FIG. 1) stores information about the detected keywords, such as a list of keywords, the number of times a keyword has been inspected in the scanned file or in all files of the group, and so on. The scan of keywords may be carried out by the same technology and even by the same programs that scan a file for virus signatures.

From block 108, if the scanned file is not the last file of the group, then at block 110 the next file of the group is accessed, and the flow of the method returns to block 104, where the same process is repeated for this file.

However, if the scanned file is the last file of the group, then the flow of the method continues with block 112, wherein the user's profile is determined, as will be detailed hereinafter, and then with block 114, wherein the process ends.

One novel feature in the described method is employing a virus scan for determining the user's profile. Thus, two different objects are obtained during a single scan: virus detection and keywords detection.

In the flowchart of FIG. 1, block 104, which denotes a scan of a file for detecting viruses, and block 106, which denotes a scan of the file for determining keywords of a user profile, are separate operations. However, both blocks can be carried out in the same scan, i.e., a file need not be scanned twice, but only once.

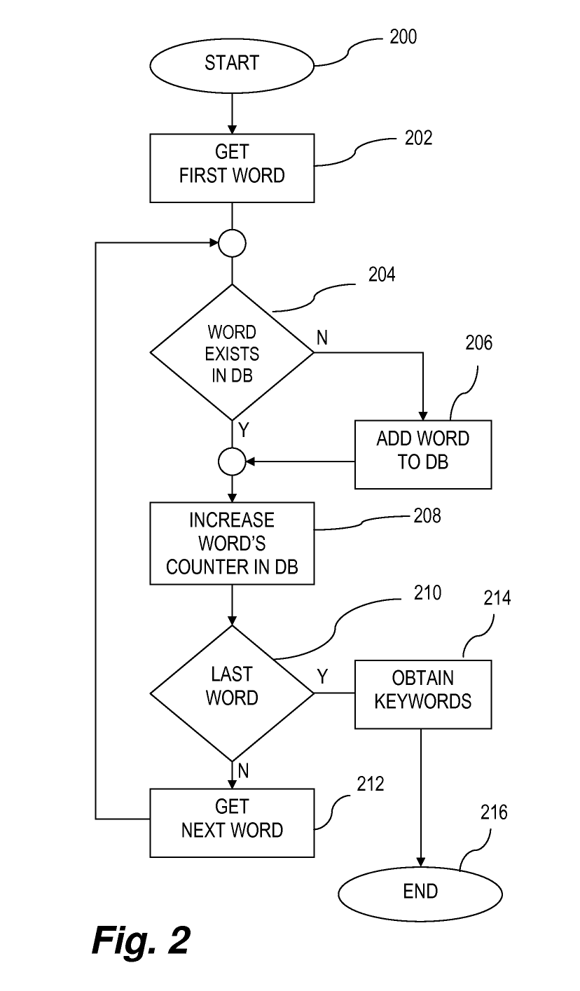

FIG. 2 schematically illustrates a simple example for obtaining a user's profile from a text file, according to one embodiment of the invention. The method illustrated in FIG. 2 expands block 106 of FIG. 1.

A text file may be treated as a string comprising one or more words. For a scanning program, a word can be defined as a string of non-space characters. Thus, a space character is treated as a delimiter, and the characters between two subsequent spaces are treated as a word. Actually, a delimiter may be also a period, a comma, a semicolon, a parenthesis, or other punctuation marks.

The method makes use of a database. A database for this purpose may be a list of memory or an organized list (e.g., by a tree structure), DBMS (the acronym of Database Management System, which is software system that allows saving, retrieving and modifying information), and so on.

In this example, the database maintains for each word/keyword a counter of the number of times the word/keyword has been detected in a file. Each of the records of the database may comprise additional counters, such as a counter for totaling the number of instances of a word/keyword in the entire group of files, and so on.

The method starts at block 200.

In block 202, the first word/keyword is detected, e.g., by analyzing the text between delimiters, as described hereinabove.

From block 204, if the word/keyword does not exist in the database, then the flow continues with block 206, in which a record associated with the word/keyword is added to the database, and then with block 208.

In block 208, the counter(s) associated with the detected word/keyword is/are increased by one.

From block 210, if the last accessed word/keyword is not the last word/keyword in the file, then at block 212 the next word/keyword is retrieved from the file, and the process repeats from block 204; otherwise, the process continues with block 214, and therefrom to block 216, wherein the process ends.

In block 214, the words/keywords of the document are determined according to the information stored in the database. For example, the words/keywords of a file may be the 5% most frequent words/keywords of the scanned file. Actually, a more sophisticated analysis can be used for characterizing a user from the words/keywords found in a group of files rather than in a single file.

Determining a user's profile by the 5% most frequent words/keywords is a simple example, demonstrating that such analysis can be carried out. A lexical analysis may be employed for obtaining information such as the most frequent subject discussed in the file, the most frequent verb in the file, and so on.

The subject of obtaining words/keywords of a file has much in common with software compilation. Software compilation is a process of translating text written in one computer language (“source language”) into another (“target language”). The original sequence is usually called the “source code”, and the output “object code”.

The program that translates from one computer language to another is called “compiler”. A compiler is likely to perform many or all of the following operations: lexical analysis, preprocessing, parsing, semantic analysis, code generation, and code optimization.

The techniques used for computer compilation may also be applied for obtaining the words/keywords of a file. Thus, some lexical analysis, semantic analysis, parsing, and so on used for computer program compilation, may also used for detecting the words that appear in a file, detecting keywords associated with the subject of the file, and so on.

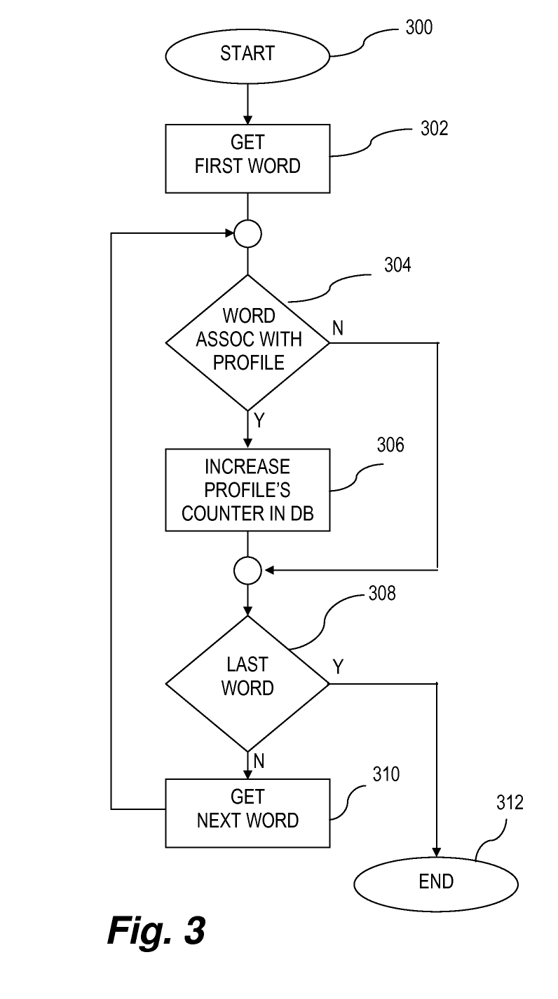

FIG. 3 schematically illustrates a simplified example for determining a user's profile from a text file, according to another embodiment of the invention.

According to this embodiment of the invention, a group of user profiles are defined in advance, each profile characterized by a group of words/keywords. The analysis determines to which of these user profiles the scanned file(s) may be related, and provides some criteria for indicating the match therebetween. For example, a correlation between the user's profile and a given profile may be expressed by a value between 0 and 100.

Practically, such analysis may calculate the correlation between a keyword found in the scanned files, its frequency and so on, with a keyword of the predefined profiles. The correlation may be a statistical criterion that describes the degree of relationship between two variables. In statistical analysis, the term “correlation” is well known.

For example, a condition for associating a user with the predefined profile “sports” is that the group comprising the keywords “football”, “baseball” and “basketball” appears in at least 0.6% of the keywords of a user's documents, and the keyword “match” appears in at least 0.05% of the keywords of these documents.

The method starts at block 300. In this block, some preliminary processing is carried out. One of the preliminary activities of this embodiment is defining a group of user profiles, i.e., the words/keywords associated with each profile, their frequency, and so on. For example, the profile of a user interested in news may comprise keywords such as “news”, “breaking news”, “party”, “politics”, “George Bush”, “Hillary Clinton”, and so on. The profile of a user interested in music may comprise the names of performers, composers, famous masterpiece titles, etc.

In block 302, the first word is detected, e.g., by analyzing the delimiters as described hereinabove.

From block 304, if the word is associated with one of the defined user profiles, then the flow continues with block 306, in which the counter associated with the profile increases by one; otherwise, the flow continues with block 308.

From block 308, if the last accessed word is not the last word of the file, then in block 310 the next word is retrieved from the file, and the process repeats from block 304. Otherwise, the process continues with block 312, where the process stops.

In this case, the user profile may be defined as the most frequent keywords of the file(s).

### Word, Keywords and Profiles

A keyword can be a word, an inflection of the word, and actually any word having relevance to the keyword. For example, as mentioned above, words such as “news”, “party”, “politics”, “George Bush”, “Hillary Clinton”, and so on may be associated with the keyword “politics”. Furthermore, a word may belong to several keywords. For example, the word “sun” may be associated with the keyword “weather”, but also with the keyword “resort”, and others.

Thus, when counting instances of a keyword, according to this example, when the word “sun” is detected, both the counter totaling instances of the keyword “weather” and the counter totaling instances of the keyword “resort” are increased.

As such, a keyword may be treated as a group of words, inflection of words, and so on, having relevance to the idea the keyword expresses, and a user profile can be treated as a group of keywords characterizing the user.

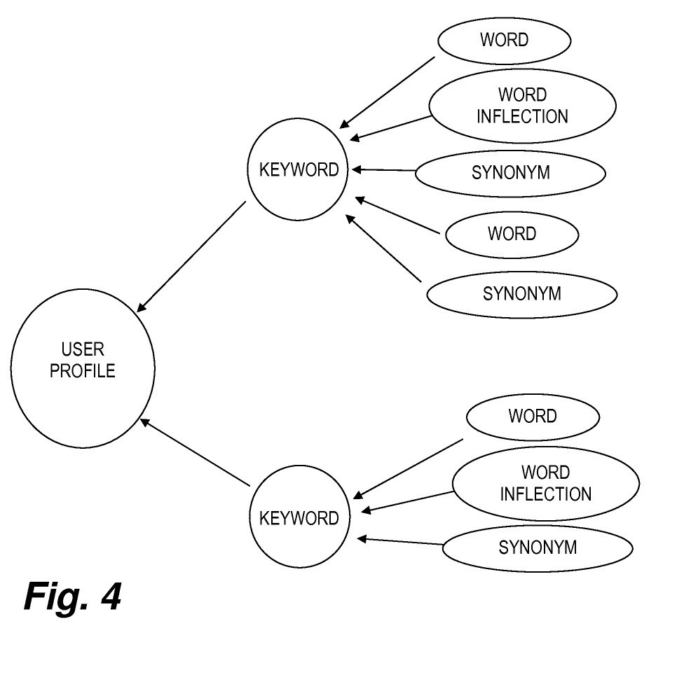

FIG. 4 schematically illustrates a structure of a user profile, according to one embodiment of the invention.

The basic entity is a word. A “word” may be the word itself, an inflection of the word, a synonym thereof, and so on.

The next entity in the hierarchy is a keyword. A keyword is a group of “words”.

The next entity in the hierarchy is a user-profile. A user profile is a group of keywords.

The arrows represent associations of one entity with another. For example, a word, an inflection of the word, and a synonym thereof, may be associated with a keyword.

### Scanning Files

One of the advantages of the disclosed technology is utilizing an antivirus scan for obtaining the keywords of the user's profile.

According to one embodiment of the invention, the scan for keywords is carried out along with the scan of viruses. For example, a keyword is actually a string pattern, and since identifying the presence of a virus in a file by a string pattern associated with a virus (also known as virus signature) is well-known technology, the same scanning utility may be used as well in searching a word/keyword, which is also of a string pattern.

When scanning a group of files for viruses, it is common that this operation is of a high priority in a computer and as such, the user thereof may be more “patient” than usual, and wait until the scan ends. In this case, the additional time and computing effort required for the keywords scan probably will not be noticed by the user thereof.

According to another embodiment of the invention, the keywords scan is carried out separately from the virus scan.

A “file” that can be scanned for words/keywords may be any data storage facility, and since data storage facilities may comprise viruses, every data storage facility may be scanned for keywords. This may include text files (e.g., of a word processor or text editor), Web files, directories, computer registry, disk storage, data passed via a port, temporary files, temporary files of a Web browser, and so on. The scan operation may be carried out “on-the-fly” (i.e., before the data is stored in a storage media) or “off-the-fly” (i.e., after the data has been stored on a storage media).

In order to speed up the keywords scan, some of the files may be omitted in this scan. For example, code files such as EXE files usually contain “Gibberish”, i.e., text non-readable by a human being, and as such, apparently without point of scanning these files for keywords. On the other hand, presence of keywords in these files may be significant, and therefore the weight of keywords found in these files, if scanned, may be greater than that of keywords found in a text file. In some files, the scan may be restricted only to the parts of the files that might comprise human-readable information, such as in the file's header.

Since only a minority of files is changed during a period, files that have not been changed since the last scan may be omitted in the scan. The time a file was created, modified and accessed is usually stored in the directory of almost any operating system. This information can be used for determining which files to scan.

In addition, some of the files can be scanned, as the information they can provide is minor, if any. For example, there is no point to scan an image file, except for its header, which may provide some pertinent information.

### Approaches for Obtaining a User Profile

The approach presented in FIG. 2 uses the most common keywords of a user's files as the user profile. In the approach presented in FIG. 3, the user profile (i.e., the keywords associated with a user) is related to one of the profiles of a group of predefined user profiles. The approach presented in FIG. 3 spares the need to store a database of every word/keyword found in the user's files, and alternatively to find one or more predefined profiles that the user can be associated with.

### Dispatching a User Profile to a Remote Database

A user's profile may be sent to a remote database over the Internet.

Once the user's profile is available on a remote database, it can be used for focusing information presented to the user. For example, as mentioned above, Google™ focuses ads to users by selecting those associated with searched words. According to embodiments of the present invention, the user's profile, which also comprises keywords, is used in the same manner. This provides significantly better focusing than the approach used by search engines, since the keywords directing the information presented to a user have some relation to the user's preferences. For example, when searching Web sites containing the word “sun”, the ads presented to a user whose profile indicates an interest in holidays may differ from those presented to a user with interest in weather.

Actually, any Web site, content channel, and so on, can focus the information presented to a user according to the user's profile. A news Web site may present to a user articles that according to his profile might interest him, an auction Web site may present to the user bids on subjects he is interested in, and so on. Advertising is one of the information entities that can be focused according to the user profile.

### Legal Obstacles

Dispatching information out of a user computer may be illegal in some countries, as it may violate the user's rights to privacy. However, the following business model may be employed in order to legalize provision of collected information from a user's computer:

According to one embodiment of the invention, a user agrees to the creation and dispatch of his profile to a remote database, and in return, he is remunerated by obtaining a license for using an antivirus program free, or at least at a reduced price. Thus, on the one hand the antivirus scan can be used for obtaining the user's profile, and on the other hand the antivirus manufacturer of the program can sell the user's profile to a third party, instead of selling the user a license for using the antivirus program.

According to one embodiment of the present invention, instead of dispatching the user profile to a remote server, the server “asks” the user's computer whether the user's profile comprises certain field of interest, and if the answer is positive, then the pertinent information is provided to the user.

According to one embodiment of the invention, a user may be asked to confirm each keyword of his profile, before adding the keyword to his profile. For example, a user may not be interested that his political opinions, his sexual preferences, and so on, will be provided to another party. By asking a user to confirm each keyword of his profile, his privacy is kept. In the event his name is present in the keywords of his profile, the user is given the option to remove his name from the profile. For example, if the name of the user is Bill Clinton, although he is not a former president of USA, his name may be one of the keywords of his profile.

### Benefits of the Present Invention

In contrast to the prior art, in which a user can fake his profile, according to embodiments of the present invention the user cannot fake his profile, since it is derived from objective information, such as the letters he writes, the Web pages he browses, etc.

The user profile, whether an individual, an organization, a group of users (e.g., of an Internet Service Provider), and so on, is characterized by the keywords found in files, without need of the user's intervention.

The activity of obtaining a user profile can be a byproduct of scanning his computer for viruses, rather than a separate operation.

The business model presented herein provides benefits for all involved: users, antivirus companies, and advertisers.

The invention can be implemented for any content service provision, such as ads presented when browsing a Web page, RSS (Really Simple Syndication).

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A method for creating a user profile, the method comprising the steps of:
while scanning a group of files of a user:
searching for keywords in said group of files;
counting the number of instances of each of the found keywords in said files; and
determining a profile of said user from the found keywords and/or said number of instances.

2. A method according to claim 1, further comprising the step of providing to said user information pertinent to the determined user profile.

3. A method according to claim 2, wherein said information comprises one or more ads.

4. A method according to claim 3, further comprising the step of remunerating said user for allowing using the determined profile for focusing information provision to said user.

5. A method according to claim 4, wherein the remuneration thereof is using an antivirus program free of charge, or for a reduced charge.

6. A method according to claim 1, wherein said user is selected from a group comprising: an individual, a plurality of individuals, an organization.

7. A method according to claim 1, wherein each of said keywords is selected from a group comprising: one or more words associated with said keyword, inflection(s) of a word, and a synonym(s) of a word.

8. A method according to claim 1, wherein said keywords are determined using compilation technology.

9. A method according to claim 1, wherein said determining a profile of said user from the found keywords is carried out using a criterion thereof.

10. A method according to claim 1, wherein said keywords are defined in advance.

11. A method according to claim 1, further comprising the steps of: determining prior to the scanning a plurality of user profiles; and relating said user to one or more of these profiles by the number of instances of the keywords associated with the profile

12. A method according to claim 1, wherein said keywords are determined during the scan, from the found words in the scan.

13. A method according to claim 1, wherein said scanning a group of files is an antivirus scan.

14. A method according to claim 1, wherein said files reside on a computer.

15. A method according to claim 1, wherein said files reside on a cellular apparatus.

16. A method according to claim 1, wherein said files are data passed in a network gateway.

17. A method according to claim 1, wherein said files are data passed in a proxy server.

18. A method according to claim 1, wherein said scanning is carried out on-the-fly or off-the-fly.

19. A method according to claim 1, wherein said files are human-readable files.

20. A method according to claim 1, wherein said files are selected from a group comprising: text files, Web files, computer registry, disk storage, data passed via a port, temporary files, temporary files of a Web browser, list of files.
